(19) United States
(12) Patent Application Publication
(10) Pub. No.: US 2022/0229699 A1
(43) Pub. Date: Jul. 21, 2022

(54) DYNAMIC DATABASE THREAD ALLOCATION TO APPLICATIONS

(71) Applicant: VMware, Inc., Palo Alto, CA (US)

(72) Inventors: Abhinandan Gatti, Rajasthan (IN); Aishwary LNU, Bihar (IN); Susobhit Panigrahi, West Bengal (IN); Siddharth Bora, Karnataka (IN); Reghuram Rajakumar Vasanthakumari, Karnataka (IN)

(21) Appl. No.: 17/152,940

(22) Filed: Jan. 20, 2021

(51) Int. Cl. G06F 9/50; G06F 9/30; G06F 9/455

(52) U.S. Cl. CPC G06F 9/5027; G06F 9/5016; G06F 9/3009; G06F 2009/45583; G06F 2209/5022; G06F 2209/508; G06F 9/45558

(57) ABSTRACT

Described herein are systems, methods, and software to manage thread allocation for applications to access a database. In one implementation, a coordination service may identify applications to be deployed in a computing environment and allocate each of the applications to a queue of a plurality of queues based on qualities of service for the applications. The coordination service may further select the applications from the plurality of queues and allocate threads to each of the applications to interact with a database based on requirements for the applications. The coordination service may also monitor resource usage by the applications at the database, determine a thread allocation modification for one or more of the applications based on the resource usage, and initiate a thread allocation modification.

### TECHNICAL BACKGROUND

In computing environments, databases can be accessed by a plurality of applications or services distributed across the network. These applications may write data to the database, extract or identify data from the database, or perform some other operation with respect to the database. In some examples, databases may be configured with master and slave nodes, wherein the master is considered the authoritative source, while the slaves provide duplicated versions of the master. As a result, depending on the requirements of the applications, an application may require a connection with the database master node over any of the slave nodes.

As the number of applications increase in communicating with the database, difficulties can arise in allocating connections or threads to applications to access the database. In examples, master and slave nodes may have a limited number of threads, causing administrators to estimate the number of threads that might be required by the application to ensure additional threads are available for other applications. Moreover, while an application may require a particular number of threads during the initial time period, the thread requirement may increase or decrease during the life cycle of the application.

### SUMMARY

The technology described herein provides dynamic thread allocation for applications to access a database. In one embodiment, the coordination service monitors computing resource usage associated with a first thread allocation configuration for the applications to interact with a database and determines an update to the first thread allocation configuration based at least on the computing resource usage, wherein the update adds or removes threads allocated to at least one of the applications. Once the update is determined, the coordination service initiates the update to the first thread allocation configuration.

### BRIEF DESCRIPTION OF THE DRAWINGS

FIG. 1 illustrates a computing environment to manage thread allocation for applications to access a database according to an implementation.

FIG. 2 illustrates an operation of a coordination service to allocate database threads to applications according to an implementation.

FIG. 3 illustrates an operation of a coordination service to dynamically allocate threads to applications according to an implementation.

FIG. 4 illustrates a timing diagram to dynamically allocate threads to applications according to an implementation.

FIG. 5 illustrates a timing diagram to dynamically allocate threads to applications according to an implementation.

FIG. 6 illustrates an operational scenario of allocating database threads to applications according to an implementation.

FIG. 7 illustrates a computing system to provide a coordination service for allocating database threads to an application according to an implementation.

### DETAILED DESCRIPTION

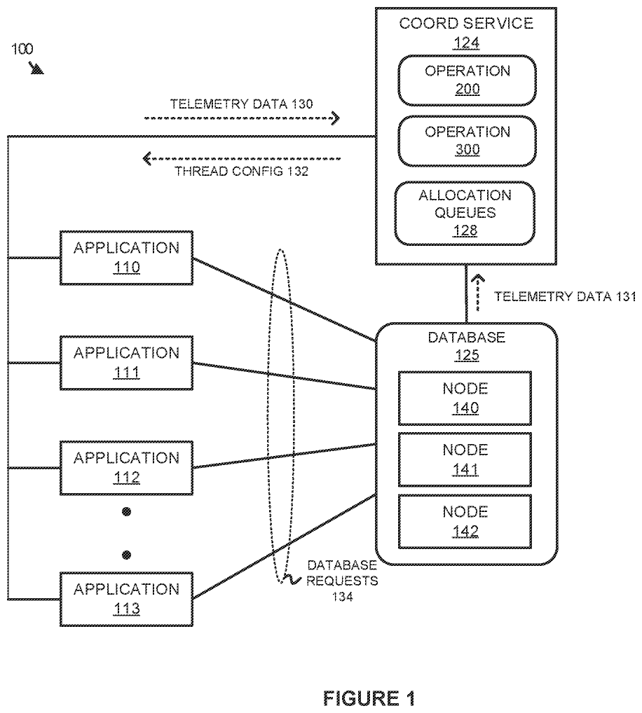

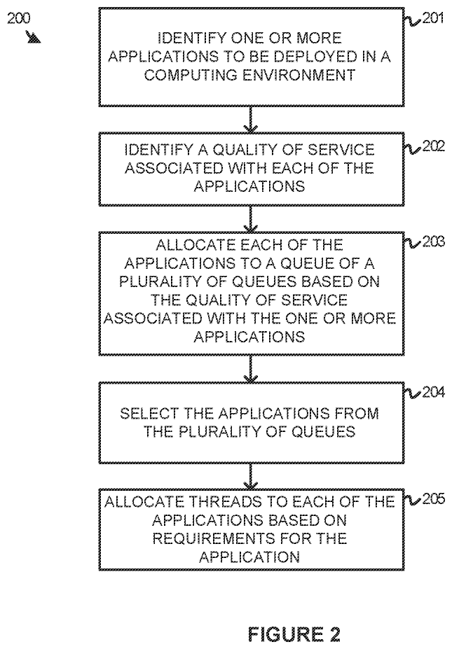

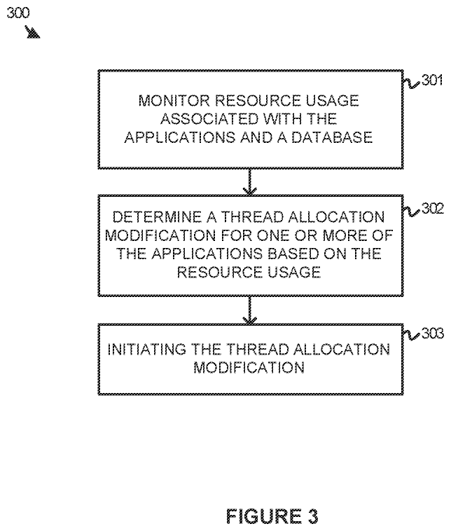

FIG. 1 illustrates a computing environment 100 to manage thread allocation for applications to access a database according to an implementation. Computing environment 100 includes applications 110-113, database 125 with nodes 140-142, and coordination service 124. Coordination service 124 further includes allocation queues 128 and provides operation 200 that is further described below in FIG. 2 and provides operation 300 that is further described below in FIG. 3. Computing environment 100 further includes telemetry data 130-131 (computer resource usage information) that is supplied by database 125 and applications 110-113 and includes thread configuration 132 that is supplied by coordination service 124 to applications 110-113.

Applications 110-113 are deployed in computing environment 100 to perform various operations in association with database 125. These operations may require reads from database 125 or may require writes to database 125. Applications 110-113 may run on virtual machines, containers, or some other virtualized endpoint. Each of application of applications 110-113 may be associated with a different quality of service based on the owner of the application or the types of operations provided by the applications. Based on the quality of service, coordination service 124 may allocate threads or connections to the application to support the required requests to database 125, wherein multiple threads may permit an application to use concurrent requests to the database.

In some implementations, coordination service 124 maintains allocation queues 128, wherein each of the allocation queues is associated with a quality of service. When a new application is identified for deployment in computing environment 100, coordination service 124 may identify a quality of service associated with the application and assign the application to a queue of the allocation queues. As the applications are assigned to the queues, coordination service 124 may pull applications from the front of the queues and allocate threads to the applications. In some examples, the queue or queues with the higher quality of service may be selected more frequently or at a higher rate than the queue or queues with a lower quality of service. As an example, coordination service 124 may maintain two queues associated with two qualities of service. Coordination service 124 may select multiple applications from the queue with the higher quality of service prior to selecting a single application from the queue with the lower quality of service. In some implementations, coordination service 124 may select an application from a queue when threads are available for the application, may select an application from a queue at periodic intervals, or may select an application based on some other interval. In some examples, each node of database 125 may have a limited number of threads for the applications to communicate with the node. For example, a master node may have two-hundred available threads and each of the child nodes may have two-hundred available threads. Threads that are not allocated to other applications may be allocated to new applications selected from the queues.

Once the applications are deployed with the allocated threads, applications 110-113 may generate database requests 134 limited based on the amount of threads allocated to the applications. While applications 110-113 interact with database 125, coordination service 124 may obtain telemetry data 130-131, which includes computing resource usage information by the various applications. The computing resource usage may include processing resources (e.g., CPU) used at the database by each of the applications, memory resources used at the database by the applications, or some other computing resource usage associated with the database interactions. This information may be measured for each of the applications by the one or more computing systems providing the database. Based on the computing resource usage, coordination service 124 may determine an update to the thread allocation configuration, wherein the update may be used to add or remove threads allocated to one or more of the applications. In some examples, the update may be based on the resource usage associated with the most current configuration, wherein an application causing increased load in a current configuration may be allocated one or more additional threads. In other examples, the update may be based on predictive modeling for the applications to predict the number of threads required by each of the applications based on the resource usage during one or more previous thread allocation configurations.

In some implementations, database 125 may include a master node and child nodes, wherein the master is considered the authoritative source or the controlling version of the data, while the slaves provide duplicated versions of the master. Depending on the requirements of the application, the application may be allocated threads associated with the master node over threads associated with a slave node. The type of threads required by the application may be based on whether the application is required to write data to the database, whether the application requires strict or eventual consistency, or based on some other factor. Strict consistency requires that when a write is generated to a first node of the database, the write is propagated to the other nodes and an acknowledgment is provided back to writer confirming the propagation. In contrast, eventual consistency may write data to a first node that provides an acknowledgment to the write and the data is eventually propagated to the other nodes without further acknowledgment.

FIG. 2 illustrates an operation 200 of a coordination service to allocate database threads to applications according to an implementation. The steps of operation 200 are referenced parenthetically in the paragraphs that follow with reference to computing environment 100 of FIG. 1.

As depicted, operation 200 includes identifying (201) one or more applications to be deployed in a computing environment, wherein the applications may be deployed as virtual machines or containers. In response to identifying the one or more applications, operation 200 identifies (202) a quality of service associated with each of the one or more applications. In some implementations, when an application is to be deployed in computing environment 100, an administrator may expressly indicate the quality of service associated with the application. In other implementations, the quality of service may be determined based on attributes associated with the application. These attributes may include the name of the application, types of database operations associated with the application (e.g., read, write, etc.), the consistency associated with the application, or some other information associated with the application.

Once the quality of service is determined for each of the one or more applications, operation 200 further allocates (203) each of the one or more applications to a queue in a plurality of queues based on the quality of service associated with the application. For example, an administrator may indicate that a first application is allocated a first quality of service, while a second application is allocated a second quality of service lower than the first quality of service. Accordingly, the first application may be allocated to a queue associated with the first quality of service, while the second application is allocated to a queue associated with the second quality of service.

As the applications are added to the queues, operation 200 further selects (204) the one or more applications from the queues and allocates (205) database threads to each of the one or more applications based on requirements for the application. In some implementations, when a request is generated to deploy the application, information about database operations for the application may be provided. The database operations may indicate a consistency level required for the application (i.e., eventual consistency or strict consistency), may indicate whether the application requires reads or writes to the database, or may provide some other database operation associated with the application. In some implementations, database 125 may include master and slave nodes, wherein the master is considered the authoritative source, while the slaves provide duplicated versions of the master. As a result, depending on the operational requirements for an application, the application may require threads for the master instead of threads for a slave or slaves. For example, a first application that writes to the database may be allocated one or more threads to the master, while a second application that only reads from the database may be allocated threads to one or more slaves. In another example, a first application that requires strict-consistency may be allocated one or more threads for the master, while a second application that requires eventual-consistency may be allocated one or more threads from the child node or nodes. When an application is selected from the front of the queue, coordination service 124 may determine the types of threads that are required for the application based on the database operations and allocate the required queues to the application. If the threads are not available, coordination service 124 may wait to allocate the threads until the threads become available, such as when an application is removed from the computing environment.

In some examples, in selecting the applications from the first-in first-out queues, coordination service 124 may select more applications from a queue or queues associated with a higher quality of service in relation to another queue or queues associated with a lower quality of service. For instance, coordination service 124 may select five applications from a first queue associated with a first priority, prior to selecting a single application from a second queue associated with a second priority.

In some implementations, each application of applications 110-113 may be associated with a default quantity of threads to interact with database 125. The default quantity may be expressly provided by the user requesting the application or may be determined based on the name of the application or any other attribute associated with the application. Once applications 110-113 are initiated on one or more host computing systems, coordination service 124 may obtain telemetry data 130-131 that corresponds to computing resource usage by each of the applications. The telemetry data may be used to dynamically modify the thread configuration associated with the applications in computing environment 100.

FIG. 3 illustrates an operation 300 of a coordination service to dynamically allocate threads to applications according to an implementation. The steps of operation 300 are referenced parenthetically in the paragraphs that follow with reference to systems and elements in computing environment 100 of FIG. 1.

As described herein, applications 110-113 are deployed in a computing environment 100 to provide various operations with respect to database 125. Applications 110-113 may execute on virtual machines, containers, or some other virtualized endpoint, and may execute on physical computing systems in some examples. When the applications are deployed, coordination service 124 may allocate threads to each of the applications as part of a thread allocation configuration. These threads may be used to limit the number of operations or processes performed by each application at the database. For example, an application may be limited to three threads to provide parallel requests to the database, while another application may be limited to ten threads. These threads may be limited to a master node, may be limited to one or more slave nodes, or may be some combination thereof.

Once a first thread allocation configuration is implemented for applications 110-113, operation 300 may monitor (301) computing resource usage associated with the first thread allocation configuration for applications to interact with the database. In some implementations, the database nodes and/or the applications may report the computing resource usage information as telemetry data, wherein the usage information may be provided periodically, at intervals based on load at the database nodes, or at some other interval. The computing resource usage information may include processing resource usage at the database associated with each of the applications, memory resource usage at the database associated with each of the applications, or some other computing resource usage information. In particular, the computing resource usage for each of the applications may be measured at the computing system or systems that provide the database.

As the resource usage is monitored, operation 300 further determines (302) an update to the first thread allocation configuration based at least on the computing resource usage, wherein the update adds or removes threads allocated to at least one of the applications. Once determined, operation 300 initiates (303) the update to the first thread allocation configuration. In some implementations coordination service 124 may, for each application, determine whether resource usage satisfies one or more criteria. For example, coordination service 124 may determine whether the resource usage as a function of time and the number of threads allocated to the application meets criteria to add at least one thread to the application. If the resource usage does not satisfy the one or more criteria, then an update may not be identified for the application. However, if the resource usage does satisfy the criteria, then coordination service 124 may identify an update to allocate at least one additional thread to the application. Advantageously, when coordination service 124 identifies an increased resource load for the threads allocated to an application, coordination service 124 may allocate additional threads to limit the load on each individual thread by the application. Although demonstrated in the previous example as adding threads available to an application, it should be understood that similar operations may be used to reduce the number of threads allocated to an application.

In some examples, to determine the update to the first thread allocation configuration, coordination service 124 may determine a prediction for resource usage based at least on the computing resource usage during the first thread allocation configuration. The prediction may include predicted computing resource usage by the application as a function of time. For example, coordination service 124 may identify that an application periodically uses increased computing resources using the first thread allocation configuration. To accommodate the increased usage, coordination service 124 may allocate, as part of an update, additional threads to the application prior to the periodic intervals to anticipate the increased usage. This prediction of resource usage by each of the applications may be based on more than a single thread allocation configuration. In particular, in addition to monitoring the resource usage associated with the first thread allocation configuration, coordination service 124 may monitor one or more additional thread allocation configurations for the applications to predictively identify updates that can add or remove threads allocated to one or more of the applications. The prediction for resource usage may be based at least partially on a function of the resource usage per thread allocated to the application.

In some implementations, when new applications are to be deployed in the computing environment, the new applications may be favored over existing applications to receive additional threads. For example, if limited thread resources are available for a master node, a new application may be allocated threads for the master node prior to allocating threads to any executing applications. If no remaining threads are available for the executing application or applications, the configuration associated with the applications may not be updated. Further, a notification may be provided to a user or administrator associated with computing environment 100 indicating that the limit has been reached for the associated node.

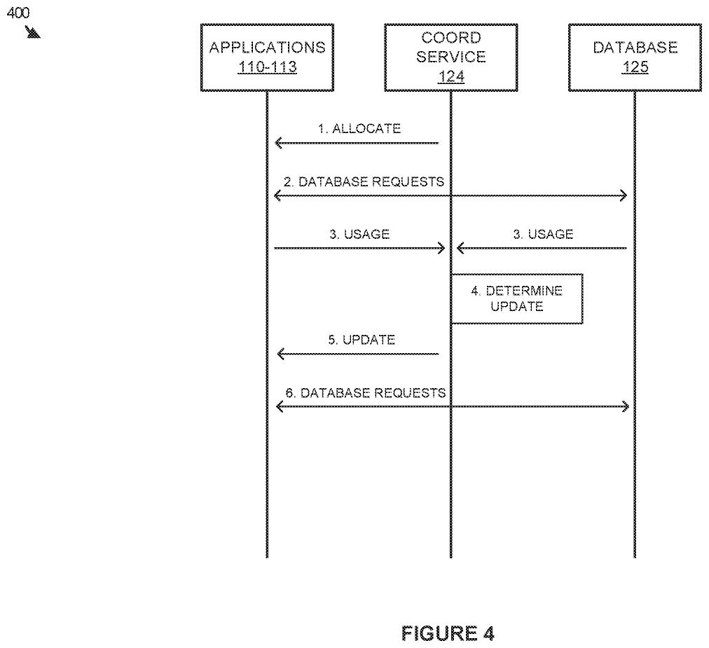

FIG. 4 illustrates a timing diagram 400 to dynamically allocate threads to applications according to an implementation. Timing diagram 400 includes applications 110-113, coordination service 124, and database 125 of FIG. 1.

In operation, coordination service 124 may identify applications 110-113 to be deployed in the computing environment to provide various operations using database 125, wherein applications 110-113 write and/or read data from database 125. In some implementations, when an application is identified to be deployed in the computing environment, the application may be placed in a queue based on the quality of service for the application. Once allocated to a queue, coordination service 124 may select an application from the queue and allocate, at step 1, threads to the application to support the application. In some implementations, the queues may each be associated with rates from which applications are pulled from queues. In particular, the applications may be selected from a queue or queues with a better quality of service at a higher rate than a queue or queues with a lower quality of service. In some examples, the threads that are allocated to each of the applications may be based on requirements associated with the applications. These requirements may include indicating whether the application will read or write data, a consistency level associated with the application (i.e., eventual consistency or strict consistency), or may provide some other requirements associated with the application. Based on the requirements, the application may be allocated threads for the master node, e.g., a node that requires writes with strict consistency, or may be allocated threads for a slave node, e.g., a node that requires eventual consistency or only requires reading data from the database.

Once applications are deployed with threads for database 125, applications 110-113 may exchange, at step 2, database requests to read or obtain data from database 125 or write data to database 125. While exchanging the database requests, coordination service 124 further receives, at step 3, resource usage information from applications 110-113 and/or database 125, wherein the resource usage information corresponds to computing resources used in association with each of the applications at database 125. The resource usage information may include processing resources, memory resources, and the like. As the information is obtained, coordination service 124 determines, at step 4, a modification or update to the thread allocation configuration and initiates, at step 5, the update to the configuration of at least one application of applications 110-113. In some implementations, coordination service 124 may determine when the usage information associated with an application satisfies one or more criteria to modify the configuration. For example, coordination service 124 may determine when the resource usage by application 110 per thread exceeds a threshold amount of usage (processing resource usage and/or memory resource usage at the database). Once the usage exceeds the threshold, coordination service 124 may allocate one or more additional threads to coordination service 124. The amount of new threads allocated may be based on the resource usage, may be a preset number of threads, or may comprise some other number of threads. Once allocated, applications 110-113 may generate, at step 6, database requests using the updated thread allocation configuration and coordination service 124 may continue to monitor the resource usage by the applications at the database and update the thread allocation configuration.

In some implementations, coordination service 124 may use the resource usage to predict the resource usage for each of the applications. This prediction may be based on the resource usage associated with the current thread allocation configuration and may further be based on one or more other thread allocation configurations. For example, coordination service 124 may determine that the resource usage associated with an application increases during the same period every day. Based on the prediction, coordination service 124 may increase the thread allocation associated with the application prior to the period and may reduce the thread allocation after the expiration of the period. The allocation of the threads may be used to provide target resource usage per thread associated with the application. In some implementations, the predictive modifications to the thread allocation may be based on trends identified from one or more other applications. In particular, coordination service 124 may identify memory and/or processing resource usage trends based on current resource usage. For example, coordination service 124 may monitor resource usage as a function of time for application 110 and compare the usage to trends identified for other applications. Based on the trends for the other applications, coordination service 124 may update the configuration for the application based on the predictions derived from the trends.

In addition to changing the configuration associated with deployed applications, coordination service 124 may further deploy additional applications in the computing environment. When a new application is to be added to the environment, coordination service 124 may add the application to the queue and select the application from the queue when thread resources are available, and the application is at the front of the queue. The new applications in the queues may be favored over existing applications to receive additional threads. Thus, when a limited number of threads are available, threads may be allocated to new applications rather than existing applications.

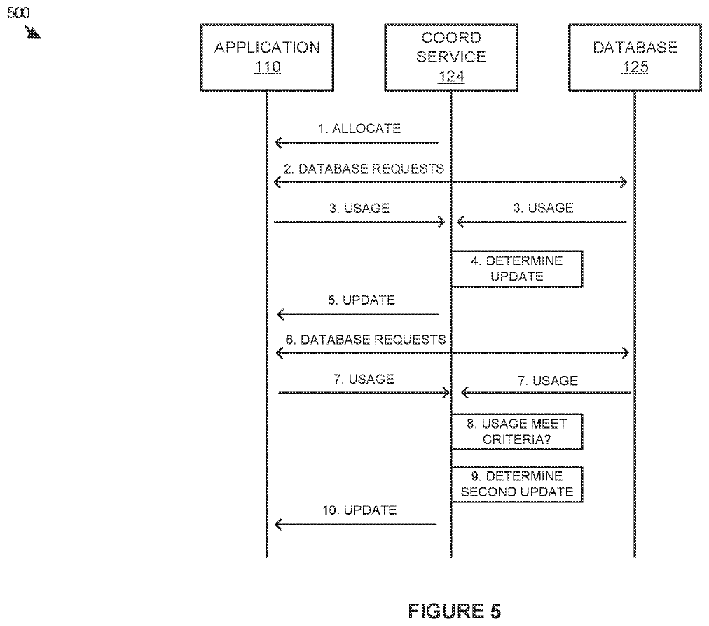

FIG. 5 illustrates a timing diagram 500 to dynamically allocate threads to applications according to an implementation. Timing diagram 500 includes application 110, coordination service 124, and database 125 of FIG. 1.

In operation, coordination service 124 identifies application 110 to be deployed in the computing environment and determines a quality of service associated with the application. Based on the quality of service coordination service 124 may allocate application 110 to a queue of a plurality of queues and process the queues until application 110 is selected for allocating threads to database 125. Once selected, coordination service 124 may identify the types of database nodes required for the application, the number of default threads required for the application, or some other configuration information associated with the application. In some implementations, coordination service 110 may determine whether to allocate threads associated with a master node, a slave node, or some combination thereof based on whether the application is required to read or write data in association with the database, based on whether the application requires strict or eventual consistency, or based on some other factor. Once the threads are identified, the threads are allocated at step 1 to application 110, wherein application 110 may execute as a virtual machine, container, or some other virtual node in some examples.

Once allocated threads, application 110 may make database requests to database 125, at step 2, and coordination service 124 may obtain, at step 3, resource usage information associated with application 110 interacting with database 125. In some examples, the resource usage information may include processing and memory resource usage by the application at database 125, wherein the usage may comprise a processing resource percentage, memory percentage, or some other statistical information about the resource usage by the application on one or more computing systems that provide or execute the database. From the resource usage information, coordination service 124 may determine, at step 4, a configuration update associated with application 110 to modify the first thread allocation configuration for the application. Once identified, coordination service 124 may update, at step 5, the thread allocation configuration for the application.

In some implementations, coordination service 124 may determine whether the resource usage associated with each of the threads for application 110 satisfies criteria to increase or decrease the number of threads allocated to application 110. For example, if the resource usage associated with the threads meets criteria to increase the threads available to the application, coordination service 124 may allocate one or more new threads to application 110. Similarly, if the resource usage associated with the threads meets criteria to decrease the threads for the application, coordination service 124 may deallocate one or more threads from application 110. The number of threads allocated or deallocated to application 110 may be based on the resource usage associated with each of the threads, may be based on a set number of threads when the application satisfies the one or more criteria, or may be determined in some other manner.

Once the update is provided to application 110, application 110 may generate requests, at step 6, to database 125 using the allocated threads and coordination service 124 may monitor, at step 7, computing resource usage associated with the allocated threads. The usage may be provided from one or more nodes in database 125 or may be provided from application 110. From the computing resource usage information, coordination service 124 may determine when the usage satisfies one or more criteria at step 8 and, when the computing resource usage satisfies the one or more criteria determine a second update for application 110 at step 9. Once identified, coordination service 124 may initiate the update to add or remove threads associated with application 110. In some implementations, coordination service 124 may determine whether the first update to the configuration provides adequate threads to support the requests of the application. If the first update fails to provide adequate threads where the application uses too many or too little computing resources, coordination service 124 may generate the second update to the thread configuration associated with the application. For example, a first update to application 110 may add a thread to the configuration but may fail to provide enough resources for the application. Consequently, a second update may be implemented by coordination service 124. The process of monitoring and updating may recursively occur to add or remove threads from the application based on resource usage at database 125.

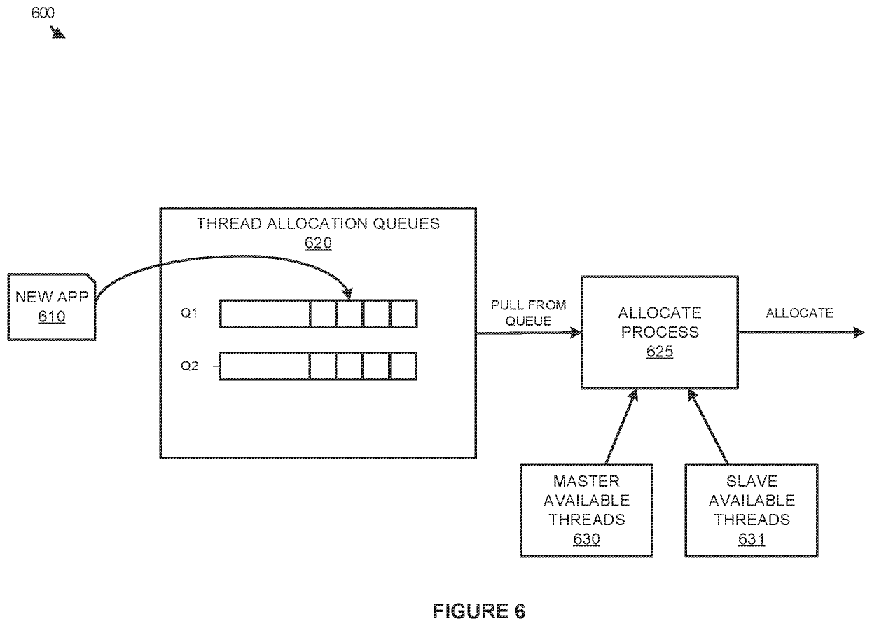

FIG. 6 illustrates an operational scenario 600 of allocating database threads to applications according to an implementation. Operational scenario 600 includes new application 610, thread allocation queues 620, allocate process 625, master available threads 630, and slave available threads 631.

In operation, a coordination service may identify new application 610 to be deployed in a computing environment as a container, a virtual machine, or some other endpoint. In response to the request, the coordination service may assign new application 610 to a queue in thread allocation queues 620 based on a quality of service associated with the application. In some examples, the quality of service may be expressly defined by an administrator deploying the application. In other examples, the quality of service may be inferred based on the name of the application, the types of requests required for the application, or based on some other factor.

Here, application 610 is allocated to Q1, wherein the coordination service may identify applications at the front of the queues and allocate threads to the applications. In some implementations, the coordination service may select applications from the different queues at a disproportionate rate. In particular, queues with a higher quality of service may have applications selected at a greater rate than applications with a lower quality of service. The applications may be selected from the queues when threads are available in the computing environment, may be selected periodically from the queues, or may be selected at some other interval. Once an application is selected from the queue, such as application 610, the coordination service may provide allocate process 625 to determine the types of queues and the quantity of queues for the application.

In some implementations, the request for deploying the application may indicate the types of threads that are required for the application. This may be determined based on whether the application will read/write data associated with the database, may be based on whether the application requires strict consistency or eventual consistency, or based on some other factor. Once the types of threads are determined for the application, allocate process 625 may allocate the required number of threads from master available threads 630 or slave available threads 631. In some implementations, the number of threads allocating to a particular application may be defined by the administrator requesting the deployment of the application. In other examples, the number of threads may be determined based on a profile associated with the application name, historical thread usage by the application during previous deployments, or based on some other factor. Once the node type and the number of threads is determined, the coordination service may allocate the threads to the corresponding application. This allocation may be delayed if the coordination service requires additional threads to become available to support the application. Alternatively, the coordination service may allocate threads to the application as the threads become available. For example, when application 110 is initially allocated threads, only three threads may be available to connect with a master node. However, at a second time, additional threads may be made available to applications as a result of other applications being removed from the computing environment or threads being deallocated from existing applications.

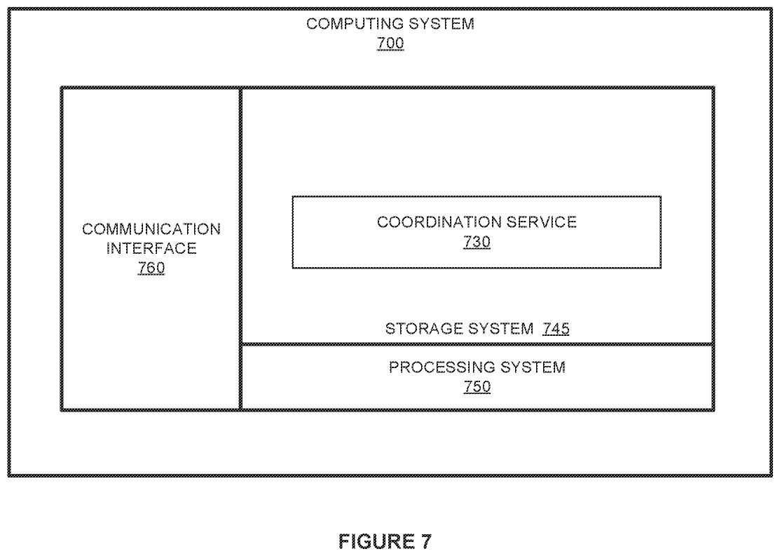

FIG. 7 illustrates a computing system 700 to provide a coordination service for allocating database threads to an application according to an implementation. Computing system 700 is representative of any computing system or systems with which the various operational architectures, processes, scenarios, and sequences disclosed herein for a user interface service can be implemented. Computing system 700 is an example of coordination service 124 of FIG. 1, although other examples may exist. Computing system 700 includes storage system 745, processing system 750, and communication interface 760. Processing system 750 is operatively linked to communication interface 760 and storage system 745. Communication interface 760 may be communicatively linked to storage system 745 in some implementations. Computing system 700 may further include other components such as a battery and enclosure that are not shown for clarity.

Communication interface 760 comprises components that communicate over communication links, such as network cards, ports, radio frequency (RF), processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format—including combinations thereof. Communication interface 760 may be configured to communicate with applications executing on one or more host computing systems, a database operating across one or more nodes, and a telemetry service capable of providing telemetry information associated with the database and applications.

Processing system 750 comprises microprocessor and other circuitry that retrieves and executes operating software from storage system 745. Storage system 745 may include volatile and nonvolatile, removable and non-removable media implemented in any method or technology for storage of information, such as computer readable instructions, data structures, program modules, or other data. Storage system 745 may be implemented as a single storage device but may also be implemented across multiple storage devices or sub-systems. Storage system 745 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing system 750 is typically mounted on a circuit board that may also hold the storage system. The operating software of storage system 745 comprises computer programs, firmware, or some other form of machine-readable program instructions. The operating software of storage system 745 comprises coordination service 730 that can provide at least operation 200 of FIG. 2 and operation 300 of FIG. 3. The operating software on storage system 745 may further include an operating system, utilities, drivers, network interfaces, applications, or some other type of software. When read and executed by processing system 750 the operating software on storage system 745 directs computing system 700 to operate as described herein.

In at least one implementation, coordination service 730 directs processing system 750 to identify requests to deploy applications in a computing environment. In response to the requests and for each application, coordination service 730 directs processing system 750 to identify a quality of service associated with the application and assign the application to a queue of a plurality of queues for allocating threads to the application. In some examples, each of the queues may correspond to a quality of service that can be determined based on an identifier or name for the application, based on a quality of service assigned by an administrator, or based on some other factor. Once assigned, coordination service 730 directs processing system 750 to select the applications from the queues, wherein applications may be selected from the queues periodically, as threads are made available, or at some other interval. Once selected, each of the applications are allocated threads to interact with the database, wherein the computing system 700 may determine the types of threads required (i.e., master or slave node threads) and the number of threads for the application. The allocation requirements may be based on whether the application is writing to the database, the consistency requirements of the application, or some other factor.

After allocating the threads to the applications, the applications may interact with the database using the available threads. During the execution of the applications, coordination service 730 directs processing system 750 to monitor computing resource usage associated with the thread allocation configuration for the applications interacting with the database. The computing resource usage information may be obtained from the nodes of the database or the applications. The computing resource usage may be associated with the processing resources of the database being consumed by the threads allocated to each application, the memory resources of the database consumed by the threads allocated to each application, or may comprise information about some other computing resource for the database in association with each of the applications.

As the computing resource usage is monitored, coordination service 730 directs processing system 750 to determine an update to the thread allocation configuration for the applications based on the computing resource usage and may initiate the update to the thread allocation configuration. The update may be used to add or remove threads for one or more applications. In some examples, the update may be triggered by current computing resource usage associated with an application satisfying update criteria, such as processing system usage associated with an application exceeding a threshold. Once satisfied, coordination service 730 may determine an update to the configuration based on the usage. Using the previous example, the update can be used to make one or more additional threads to the application. The amount of threads that are added may be based on the computing resource usage, may be a set number of threads when the criteria are satisfied, or may be determined in some other manner.

In some implementations, in addition to or in place of using current resource usage to trigger the update, coordination service 730 may determine the update to the thread allocation configuration based on a prediction for the resource usage by the applications. This prediction may be based on the current configuration and may further be based on one or more other previous thread allocation configurations for the applications. The prediction may be used to identify trends associated with the resource usage for each of the applications. For example, an application may use greater resources during periodic time periods. Consequently, coordination service 730 may increase the number of threads allocated to the application. The increase or decrease in threads may be used to provide a target amount of resource usage per thread by the application.

In another example, in addition to identifying trends associated with a current application, trends may also be identified from other applications and/or an administrator associated with the computing environment. These trends may be used to identify a current status for the application, using the current computing resources for the application (processing and memory resources at the database for the available threads) and predict whether additional threads or less threads are required for the application. In some implementations, the current resource usage associated with the application may be applied to a data structure to determine whether to increase the number of threads, decrease the number of threads, or maintain the same number of threads. The data structure may be populated by the administrator or may be learned based on trends identified from other applications.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
monitoring computing resource usage associated with a first thread allocation configuration for applications to interact with a database;
determining an update to the first thread allocation configuration based at least on the computing resource usage, wherein the update adds or removes one or more threads allocated to at least one of the applications; and
initiating the update to the first thread allocation configuration.

2. The method of claim 1, wherein the computing resource usage comprises processing resource usage of one or more computing systems that provide the database by each of the applications and memory resource usage of one or more computing systems that provide the database by each of the applications.

3. The method of claim 1, wherein the first thread allocation configuration indicates a number of threads allocated to each of the applications for accessing the database.

4. The method of claim 1 further comprising:
determining that the computing resource usage associated with the at least one application exceeds a threshold for processing resource usage or memory resource usage at the database;
in response to the at least one application satisfying the one or more criteria, determining the update to the first thread allocation configuration based at least on the computing resource usage.

5. The method of claim 1, wherein determining the update to the first thread allocation configuration based at least on the computing resource usage comprises:
determining a prediction for future resource usage that is expected to be utilized by the applications based at least on the computing resource usage;
determining the update to the first thread allocation configuration based on the prediction.

6. The method of claim 5 further comprising:
monitoring computing resource usage associated with one or more second thread allocation configurations; and
wherein determining the prediction for resource usage is further based on the computing resource usage associated with the one or more second thread allocation configurations.

7. The method of claim 1 further comprising:
identifying one or more additional applications to be added to the applications;
identifying a quality of service associated with each of the one or more additional applications;
for each of the one or more additional applications, allocating the application to a queue in a plurality of queues based on the quality of service associated with the application;
selecting the one or more additional applications from the plurality of queues in accordance with one or more rates associated with the plurality of queues; and
allocating one or more threads to each of the one or more additional applications when selected.

8. The method of claim 1, wherein the database comprises a master node and at least one child node.

9. The method of claim 1, wherein the applications each execute in a container on a host or a virtual machine on a host.

10. A computing apparatus comprising:
a storage system;
a processing system operatively coupled to the storage system; and
program instructions stored on the storage system that, when executed by the processing system, direct the computing apparatus to:
monitor computing resource usage associated with a first thread allocation configuration for applications to interact with a database;
determine an update to the first thread allocation configuration based at least on the computing resource usage, wherein the update adds or removes one or more threads allocated to at least one of the applications; and
initiate the update to the first thread allocation configuration.

11. The computing apparatus of claim 10, wherein the computing resource usage comprises processing resource usage of one or more computing systems that provide the database by each of the applications and memory resource usage of one or more computing systems that provide the database by each of the applications.

12. The computing apparatus of claim 10, wherein the first thread allocation configuration indicates a number of threads allocated to each of the applications for accessing the database.

13. The computing apparatus of claim 10, wherein the program instructions further direct the computing apparatus to:
determine that the computing resource usage associated with the at least one application exceeds a threshold for processing resource usage or memory resource usage at the database;
in response to the at least one application satisfying the one or more criteria, the update to the first thread allocation configuration based at least on the computing resource usage.

14. The computing apparatus of claim 10, wherein determining the update to the first thread allocation configuration based at least on the computing resource usage comprises:
determining a prediction for future resource usage that is expected to be utilized by the applications based at least on the computing resource usage;
determining the update to the first thread allocation configuration based on the prediction.

15. The computing apparatus of claim 14, wherein the program instructions further direct the computing apparatus to:
monitoring computing resource usage associated with one or more second thread allocation configurations; and
wherein determining the prediction for resource usage is further based on the computing resource usage associated with the one or more second thread allocation configurations.

16. The computing apparatus of claim 10, wherein the program instructions further direct the computing apparatus to:
identify one or more additional applications to be added to the applications;
identify a quality of service associated with each of the one or more additional applications;
for each of the one or more additional applications, allocate the application to a queue in a plurality of queues based on the quality of service associated with the application;
select the one or more additional applications from the plurality of queues in accordance with one or more rates associated with the plurality of queues; and
allocate one or more threads to each of the one or more additional applications when selected.

17. The computing apparatus of claim 10, wherein the database comprises a master node and at least one child node.

18. The computing apparatus of claim 10, wherein the applications each comprise a container executing on a host or a virtual machine executing on a host.

19. A system comprising:
a database; and
a coordination service communicatively coupled to the database and configured to:
monitor computing resource usage associated with a first thread allocation configuration for applications to interact with the database;
determine an update to the first thread allocation configuration based at least on the computing resource usage, wherein the update adds or removes one or more threads allocated to at least one of the applications; and
initiate the update to the first thread allocation configuration.

20. The system of claim 19, wherein the coordination service is further configured to:
identify one or more additional applications to be added to the applications;
identify a quality of service associated with each of the one or more additional applications;
for each of the one or more additional applications, allocate the application to a queue in a plurality of queues based on the quality of service associated with the application;
select the one or more additional applications from the plurality of queues in accordance with one or more rates associated with the plurality of queues; and
allocate one or more threads to each of the one or more additional applications when selected
